(19) United States
(12) Patent Application Publication
(10) Pub. No.: US 2023/0137843 A1
(43) Pub. Date: May 4, 2023

(54) HOLOGRAPHIC VIDEO MICROSCOPY CELL VIABILITY ASSAY

(71) Applicant: SPHERYX, INC., New York, NY (US)

(72) Inventors: Mary Ann ODETE, New York, NY (US); Rostislav BOLTYANSKIY, Brooklyn, NY (US); Fook Chiong CHEONG, New York, NY (US); Laura A. PHILIPS, New York, NY (US)

(73) Assignee: SPHERYX, INC., New York, NY (US)

(21) Appl. No.: 17/976,565

(22) Filed: Oct. 28, 2022

Related U.S. Application Data
(60) Provisional application No. 63/273,526, filed on Oct. 29, 2021.

(51) Int. Cl. G03H 1/00; G01N 15/02

(52) U.S. Cl. CPC G03H 1/0005; G01N 15/0227; G03H 2001/005

(57) ABSTRACT

A holographic microscopy characterization (HMC) process for utilizing holographic video microscopy to provide an efficient, automated, label-free method of accurately identifying cell viability. Optical properties of a sample of cells are determined by HMC. The optical properties are compared to known samples or compared over time to observe changes in the optical properties, enabling identification of cells as viable or not viable, or as extra-cellular or degraded cellular materials.

### CROSS REFERENCE TO RELATED APPLICATIONS

This application claims priority to U.S. Provisional Pat. App. No. 63/273,526, filed Oct. 29, 2022, the contents of which is incorporated herein in its entirety by reference.

### STATEMENT OF GOVERNMENT INTEREST

This invention was made with government support in part by the National Center for Advancing Translational Sciences of the National Institutes of Health under Award Number R44TR001590. The government has certain rights in the invention.

### BACKGROUND

Although assessment of cell viability is a challenge in many applications, including biologics manufacturing, traditional approaches often include unreliable labeling with labeling, involving the use of dyes and/or time consuming methods of manually counting cells. Frequently the staining leverages that live cells include an intact cell membrane while dead cells frequently lack an intact cell membrane, for example utilizing a DNA binding dye that will selectively bind with dead cells by penetrating the compromised cell membrane. Similarly labeling more generally relies upon altering one or more of the dead cells or live cells to enable identification.

Existing cell viability assays present several challenges and undesirable characteristics. There is a need for a non-invasive process that does not require modification of the target cells such as by binding with a dye. Further, a labeling often is unable to identify dead cells that have broken down beyond a certain point. So while many labeling approaches rely on the cell wall not being intact, they also rely on the cell maintaining some structural integrity. Thus, where cells have been destroyed or significantly broken down, current cell viability assays may undercount the number of dead cells.

### SUMMARY OF THE INVENTION

At least one embodiment relates to a holographic microscopy characterization (“HMC”), which is a technique that harnesses holographic video microscopy to provide the capability of presented here as an efficient, automated, label-free method of accurately identifying cell viability. This summary is illustrative only and is not intended to be in any way limiting.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1A shows a schematic of holographic video microscopy: as cells flow through a microfluidic chip, they are illuminated by a laser beam. Light scattered by the particles interferes with the incident light, forming holograms which are recorded on a camera. FIG. 1B shows a scatter plot of size on the horizontal axis and refractive index on vertical axis for 4 species of particles: 1:51 µm diameter polystyrene spheres (in cyan), 2:56 µm diameter polystyrene spheres (in violet), 1:49 µm diameter silica spheres (in orange), 2:63 µm diameter silica spheres (in yellow). Each point on the plot represents a single particle detected with Holographic video microscopy during measurement. The colored boxed are user-defined regions of interest. Particles outside of the 4 user-defined boxes are colored gray.

FIG. 2A shows a scatter plot of size on the horizontal axis and refractive index on vertical axis for a yeast sample before the addition of alcohol. Each point on the plot represents a single particle that flowed through the viewing region of the microfluidic chip during Holographic video microscopy analysis. The colored boxed are user-defined regions of interest. The points colored in orange represent dead yeast cells and the points colored in cyan represent live yeast cells. Particles outside of the user-defined boxes are colored gray. FIG. 2B shows density distributions of particle size for the sample shown in FIG. 2A. The orange, cyan and gray curves represents the size density distributions of dead cells, live cells, and all particles respectively. The area under each curve for a given size range represents the number of particles (of the species represented by that curve) in that size range. The peak of each curve shows the most common size of each particle type. FIG. 2C shows density distributions of particle refractive index for the sample shown in FIG. 2A. The coloring is the same as in FIG. 2B. The area under each curve for a given refractive index range represents the number of particles (of the species represented by that curve) in that refractive index range. The peak of each curve shows the most common refractive index of each particle type. FIGS. 2D-2F show scatter plot, size density plot, and refractive index density plot as in FIGS. 2A-2C but for a yeast sample that was exposed to 15% isopropanol by volume for 71 minutes.

FIG. 3 shows the results of exposing yeast samples to 0%, 15% and 20% isoproponal by volume, and measuring the resulting viability over time using both xSight and trypan blue (“TB”). The horizontal axis represents time after the addition of alcohol. The vertical axis represented the percentage of live cells normalized by the initial time point before alcohol was added. All solid curves are measurements with Holographic video microscopy and all dashed curves are TB staining measurements. The blue curves represent results from the control samples with no alcohol. The yellow curves represent results from samples with 15% isopropanol by volume. The orange curves represent results from the samples with 20% isopropanol by volume.

FIGS. 4A-4B show typical results of a TB exclusion assay. FIG. 4A is grid cell showing a mix of live and dead yeast cells. Live cells do not absorb the dye and appear light gray. They identified with blue arrows. Dead cells are permeable to the dye and appear dark blue/gray. They are identified with orange arrows. FIG. 4B is a grid cell showing cells with an inconclusive viability status based on the TB exclusion assay. Those with an inconclusive status are circumscribed by gray circles.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Cell viability is a key parameter of interest in many of applications. While numerous methods of measuring viability of yeast exist, most share one limitation: the need to stain cells with a dye. Dye-based methods, such as the TB exclusion assay, rely on healthy cell membranes being impermeable to the dye while the membranes of dead or damaged cells allow the dye to diffuse into the cell. Although this method is useful, it usually involves tedious sample preparation and manual cell counting. Manual cell counting suffers from low statistics and is prone to human error. Furthermore, the TB exclusion assay has been shown to overestimate viability and be unreliable for certain cell samples with a viability less than 70%-80%.

Additionally, with any dye-based staining viability measurements, there is a danger that the dye can interact either with the cells or with another experimental variable in unintended ways. As an example, trypan blue has been shown to adversely interact with cells, often rupturing them and thus rendering viability measurements unreliable. Further complicating the options for cell viability is the inhomogeneous nature of a collection of cells. The inhomogeneous shape and the tendency for dye-based methods to alter or destroy cells, exacerbates many of the problems with existing assays, particularly in regards to the inability to accurately account for all dead cells, including those that may be in severe states of decay, such as entirely lacking a cell membrane or wall to the point of being a dispersed collection of previously intra-cellular components.

HMC is a technique that harnesses holographic video microscopy to provide the capability of presented here as an efficient, automated, label-free method of accurately identifying cell viability. Holographic video microscopy is a process that characterizes a region of space, via a hologram, such as a particle, typically as single particle, characterization to determine physical properties of the particle, such as size and index of refraction, using a theory of light scattering, such as the Lorenz-Mie or Rayleigh-Sommerfeld. HMC is described further in U.S. Pat. Nos. 8,791,985, 8,766,169, 8,431,884, 8,331,019, and 7,839,551, each of which is incorporated herein by reference.

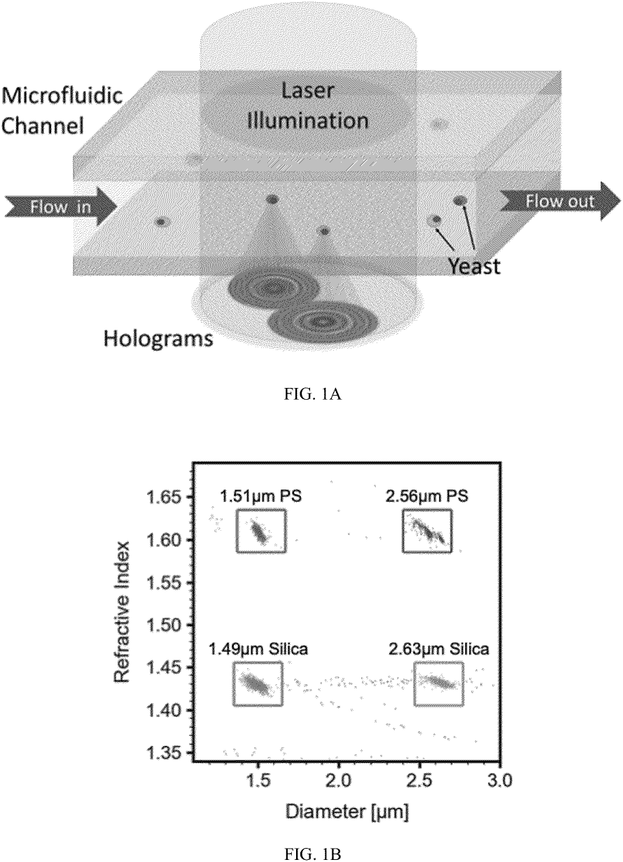

HMC, in general terms, works by flowing particles down a microfluidic channel and illuminating with coherent illumination, typically in an observation volume of the microfluidic channel. FIG. 1A shows one embodiment of a setup for HMC. Light from a collimated laser beam illuminates a sample within a microfluidic channel. An illuminated particle scatters some of that light to the focal plane of a microscope (not shown), where it interferes with the remainder of the beam. The microscope magnifies the resulting interference pattern and projects it onto the sensor of a video camera, which records its intensity. In some embodiments, multiple particles may generate holograms within the same “frame” of the video. The scattered light forms a hologram for each particle that contains detailed information about the particle. The hologram can be analyzed with Lorenz-Mie theory to get the size and refractive index of the particle. The refractive index gives information about the composition of the particle which can be used to distinguish particles even if they have the same size.

HMC is used to characterize cells in a cell viability assay. The cells are flowed through a sample volume, such as a microfluidic channel. The laser beam illuminates the sample volume, interacting with the cells present in that volume creating a hologram capturing information relating to the cells. Both live and dead cells may be characterized in this manner, with their resultant characterizations allowing determination if a given cell is “dead” or “alive” based on a comparison of the identified characteristics. For example, the experimental results discussed below confirm that cell viability can be effectively assessed using these techniques. On average, yeast cells reduced in size and increased in refractive index upon exposure to high concentration alcohol and upon eventual cell death. While an average decrease in the size of dead cells was observed compared to live ones, size alone is insufficient to distinguish the live and dead populations. Further, the inhomogeneous nature of many types of cells makes reliance on size alone inaccurate.

The results of the experiments demonstrate that the cell index of refraction is a more effective distinguishing identifier of cell viability. This conclusion is also consistent with morphological cell changes. If cells shrink due to expulsion of low index of refraction water and the remaining cell sub-components have a higher index of refraction than water, then the net index of refraction of the cell will increase as observed in the measurements. Holographic video microscopy characterizes each particle that flows through the sample volume. In some embodiments analyzes a particle, such as a cell, as a sphere. Further, particles may be an agglomeration of materials, such as the contents of a ruptured cell. Rigorously generalizing the analysis to account for the detailed structure of aspherical and inhomogeneous objects such as ruptured cells is prohibitively slow because of the analytical complexity and the associated computational burden. In some embodiments, an idealized spherical model is used to characterize such aggregates with the understanding that the results should be interpreted as referring to an effective sphere comprising both the aggregates and the fluid medium that fills out the effective sphere as described further in U.S. Pat. No. 11,385,157 and U.S. Publication No. 2021/0123848, both of which are incorporated herein by reference. The multi-parameter optimization finds an effective sphere with a hologram most similar to the hologram of the particle being analyzed. A smaller cell with stronger scattering components will be identified as a smaller particle with an increased refractive index. This scenario is consistent with the reported results. Similar changes in optical properties of cells in response to external stress, such as osmotic pressure, have been reported in other studies. In some embodiments, these parameters, as well as size and refractive index, may be used to identify specific sub-units of cells or even general debris from cells fragments.

In addition, the holographic approach described herein is also a promising way to study the progression towards cell death or other stress responses. Since many morphological changes can manifest as changes in cell size and refractive index, holographic video microscopy can be a powerful tool to quantitatively track those changes in real time where traditional cell viability assays cannot because they rely on cell death. Thus, in one embodiment, the holographic video microscopy process described herein can be used to monitor cells as they progress toward death even by comparing measured physical characteristics to a known “healthy” cell’s characteristics. It should be appreciated that the ability to monitor changes in cell viability in near-real time will be valuable for biologics manufacturing or any process that uses a bioreactor.

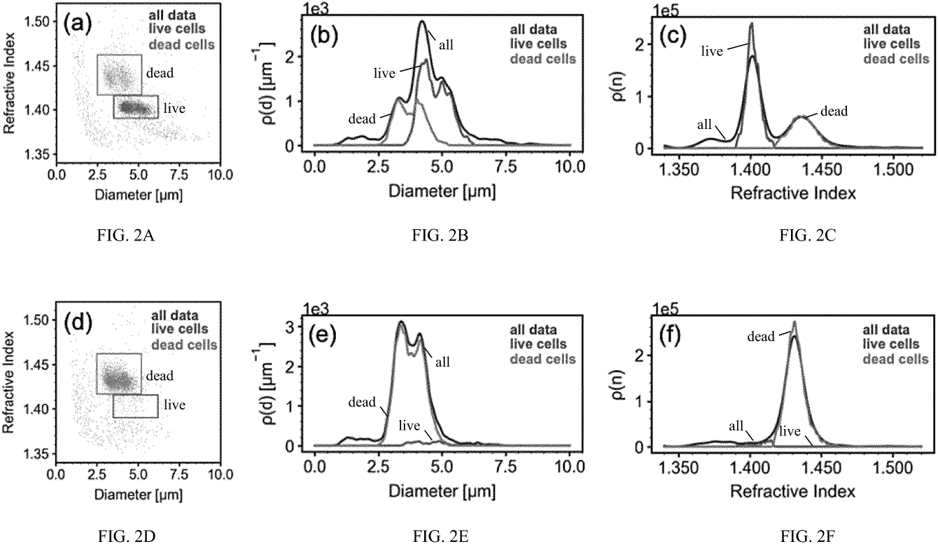

For example, as reported below, in addition to identifying live and dead cells, the technology identified a third population of particles labeled in gray in FIG. 2D. Those particles were largely smaller or lower index than what was identified as yeast cells. It is possible that those are cell fragments. They could also be aggregates either of materials produced by the yeast in solution or contaminants from other sources. The combination of size and refractive index of many of these particles is consistent with what has been observed for protein aggregates with holographic video microscopy.

As described, this work has explored the response of Saccharomyces cerevisiae to various concentrations of isopropanol as an illustrative example. Other studies have investigated cell viability in response to stresses such as other alcohols, osmotic pressure, and heat. Holographic video microscopy is a promising approach to study viability under those conditions as well. Holographic changes in cells upon death should similarly be observed in other cell types such as bacteria and animal cells. Holographic video microscopy should be a useful tool to study those biological systems as well.

The results present a powerful approach to assessing cell viability using holographic video microscopy. As can be seen in the experimental results, cell death in response to alcohol exposure was concurrent with a population increase in cell refractive index suggesting that this optical parameter is effective in identifying live and dead cells. The proposed holographic approach is fast, automated, and label-free, eliminating many of the limitations of traditional staining-based viability assays. The methodology is objective and does not require user identification of each cell once refractive index regions are identified. Therefore, Holographic video microscopy can be extended to high-throughput, automated viability analysis in a variety industrial applications.

### Experimental Results Holographic Approach to Yeast Viability

To demonstrate holographic video microscopy as a new technology for viability studies, experiments were performed using alcohol to gradually kill yeast cells, as has been done in previous yeast viability studies. The experimental results demonstrate that holographic video microscopy can effectively distinguish living and dead yeast cells by the index of refraction of individual cells. While the viability of Saccharomyces cerevisiae yeast, in particular in the presence of various concentrations of isopropanol as a function of time, is utilized as an example system for illustrative purposes, the present concepts should not be limited to that particular organism or even yeast in general. The use of yeast cells, particularly Saccharomyces cerevisiae, is ubiquitous in both industry and academia for applications from cell-based experiments to protein manufacturing. For example, in medical research yeast serves as a model organism to study genetic mutations relevant in cancer. In biopharmaceutical research and manufacturing, yeast cells are employed as mini-factories for the production of proteins of interest. Additionally, in one of the most well-known applications, yeast is used in consumer product research and manufacturing to optimize beer, wine and bread-making.

### Methods

### Yeast Preparation

The yeast solution was made using glucose (SIGMA brand, item G8270-1KG), filtered deionized (DI) water, and dry instant yeast (Amish Market store brand, New York, NY). A glucose stock mixture was made by mixing 25 g of DI water with 0.5 g of glucose until the glucose was fully dissolved. Once dissolved, the glucose mixture was filtered with a 60 cc luer lock disposable 0:45 µm syringe filter (Millex brand). If not made for immediate use, the glucose mixture was stored in a 4° C. refrigerator.

The glucose solution was diluted with filtered DIwater in a 1:1 proportion, using 4 mL of each, in a 30 mL vial. Using dry instant yeast, 4-7 pellets were placed into the diluted glucose mixture and the vial was shaken by hand and vortexed until all the yeast pellets were dissolved. The yeast solutions was incubated (Benchmark, Roto-Therm mini) at 40° C. Once the incubator was at temperature, the yeast mixture was placed into the incubator for 30 minutes. After 30 minutes, the mixture was removed from the incubator and shaken briefly to dissolve any remaining yeast. A fresh yeast mixture was made for each day of experiments.

Three alcohol concentrations were tested: 0% isopropanol (control), 15% isopropanol by volume in glucose solution, and 20% isopropanol by volume in glucose solution. Each alcohol concentration was prepared by placing the solution in a 10mL vial and bringing the final volume to a total of 2 mL. For the control and for 15% isopropanol solution, the samples were measured over approximately 90 minutes. For the 20% isopropanol solution, the samples were measured over approximately45 minutes. For the control, the stopwatch was started after the solution was vortexed. For the 15% and 20% alcohol solutions, the stopwatch was started (t = 0) once the alcohol was placed into the 10 mL vial with the yeast solution. For each condition, the viability was measured once before the alcohol was introduced and then consecutively after the addition of alcohol.

### Holographic Video Microscopy

Holographic video microscopy measurements were made using xSight (Spheryx, Inc.), Spheryx’s implementation of Holographic video microscopy. For each measurement, a 30 µL volume of sample was placed into one of the eight reservoirs on an xCell, a disposable microfluidic sample chip (Spheryx, Inc.). Flow of the sample through the microfluidic channel was established automatically in xSight by application of a vacuum seal and a pump, creating a uniform Poiseuille flow. A collimated laser beam with a vacuum wavelength of 638 nm illuminated the viewing region of the xCell while the sample flowed. Light scattering by particles in the sample interfered with incident light creating holograms that were recorded on a camera for further analysis. Each hologram was analyzed with Holographic video microscopy resulting in a multi-parameter fit for the size, refractive index, and the three-dimensional position of each particle.

For each sample, sample viscosity and refractive index of the medium (water with glucose) were measured and entered into xSight. The refractive index of the medium was measured with a hand-held refractometer (Antago, pocket refractometer). Pressing the START button initiated the measurement.

The first measurement of the yeast solution, before the addition of alcohol, was labeled as time point “t = -1” and was used to normalize the rest of the viability curve. All other time points were recorded as when the START button was pressed. The volume measured for each sample was 1 µL.

The boxes that circumscribed the live and dead yeast populations were user-defined regions of interest enabled by the xSight software. Once the regions of interest were defined, the results of the live and dead cell analyses were automatically computed producing the concentration, the median size and the median refractive index of each population. The regions were determined to delineate the distinct populations. The viability of each sample was then recorded based on the automatically computed statistics of each region.

### Staining Measurements With Trypan Blue

Staining measurements were prepared in micro-centrifuge tubes (uLab Scientific). 30 µL of yeast sample and 30 µL of the dye were mixed into the tube and allowed to stand for 2 minutes. After 2 minutes, 30 µL of the dyed sample was placed onto an Improved Neubauer Hemocytometer (Fristaden Labs). A cover slip was placed on top of the hemocytometer and viewed under a microscope (AmScope) with 10x magnification. On the hemocytometer, the cells on eight of 4x4 grid boxes were counted for the staining viability analysis. After the counting was completed, the hemocytometer was cleaned using isopropanol and DI water and dabbed with a Kimwipe. The hemocytometer was allowed to air dry fully before performing the next measurement. As with Holographic video microscopy, the time of the first measurement, before alcohol was introduced, was labeled “t = -1”. The start of the staining experiment (t = 0) was marked when the dye was introduced into the sample.

### Experiments

For experiments described herein, all holographic video microscopy measurements were performed in the native environment of the sample with no dilution or addition of labels. The results from Holographic video microscopy were compared with manual counting of living and dead cells as distinguished with trypan blue dye. The viability changes of Saccharomyces cerevisiae are shown under under various concentrations of isopropanol and compare the results with staining using trypan blue.

Holographic video microscopy was used to assess yeast viability. In some embodiments, particles in suspension (such as yeast cells) flow through a microfluidic chip as they are illuminated by a collimated laser beam. Laser light scattered by the particles interferes with the incident laser light, forming an interference pattern called a hologram. A schematic of this technology is shown in FIG. 1A.

The holograms are recorded on a camera and fit to Lorenz-Mie theory of light scattering. A fast, multi-parameter optimization of the fit then yields various particle parameters including particle size, refractive index, and 3-dimensional position that correspond to that hologram. A key advantage of this approach is that in addition to particle size, Holographic video microscopy quantifies the refractive index of each particle, which is indicative of its composition. For example, FIG. 1B shows a scatter plot of a sample that consists of a mix of four different particles species: two sizes of polystyrene microspheres and two sizes of silica microspheres. Each point on the plot represents a single particle detected by xSight during measurement. On the horizontal axis is the measured particle diameter and on the vertical axis is the measured particle refractive index. The colored boxes are user-defined regions of interest corresponding to different species of particles. The points are colored according to which region they fall into. From the scatter plot, one can easily observe 4 main particles distributions with two at a refractive index of approximately 1.61 in cyan and violet and two at a refractive index of approximately 1.43 in orange and yellow. Those pairs of distributions are polystyrene and silica microspheres, respectively. The refractive index of polystyrene in water when illuminated with a blue laser is 1.61 and a refractive index of 1.43 is consistent with porous silica It is important to note that with a standard particle sizer, only two populations would be visible in this sample: one at a particle diameter of around 1:5 µm and one at a particle diameter of around 2:6 µm. Since Holographic video microscopy measures refractive index in addition to size, particles of the same size but different composition can be easily distinguished, such as the 1:49 µm silica and 1:51 µm polystyrene spheres (in orange and cyan respectively) and the 2:63 µm silica and 2:56 µm polystyrene spheres (in yellow and violet respectively).

This technology has similarly been used to distinguish bacteria from plastic beads and oil in water since each of those species is composed of materials of different refractive indexes. A study of porous silica particles showed that Holographic video microscopy is able to detect subtle changes in particle composition. The ability to detect small changes in particle composition is due to the effective sphere model and the effective medium theory. Holographic video microscopy characterizes each particle that flows through the viewing region of the microfluidic chip and analyzes it assuming that it is a sphere. Holographic video microscopy finds an effective sphere with a hologram most similar to the hologram of the particle being analyzed. When an individual particle’s composition is heterogeneous, such that various components of a particle have different indexes of refraction, the Holographic video microscopy fitting algorithm will produce a refractive index for that particle that is an average of the refractive indexes of its various components. In the example of a porous silica particle in water, the refractive index of a given particle will be somewhere between the refractive index of the silica matrix and the refractive index of the water that fills its pores. To what extent the resulting effective refractive index will be closer to silica or closer to water depends on the particle’s porosity. Hence it is possible to extract morphological information from the behavior of the particle refractive index in media of varying refractive indexes. Quantitative morphological information about particle porosity has been studied in porous plastics, protein aggregates, and nanoparticle agglomerates.

Yeast cells are also heterogeneous particles with various cell components acting as scattering materials with different refractive indexes. Since cell death often involves physiological changes in cell structure and composition, these changes are expected to change the refractive index of the cells, and therefore should be detected by measuring the cell refractive index with Holographic video microscopy.

### Distinguishing Live and Dead Cells by Refractive Index

A typical scatter plot of Holographic video microscopy results from a yeast sample before introduction of alcohol is shown in FIG. 2A. The orange and cyan boxes are user-defined regions corresponding to dead and live yeast cells respectively. The points are colored according to which region they fall into. The orange points correspond to particles identified as dead cells, the cyan points correspond to particles identified as live cells and the gray are other particles identified as debris (see Discussion below). In the sample, shown in FIG. 2A, 51.4% of all detected particles are identified as live cells, 29.7% are identified as dead cells and 18.9% as debris.

As can be seen in FIG. 2A, while the live and dead cells overlap in size, their refractive indexes are distinct. In this sample live cells were found in the size range of 3: 5 µm to 6:2 µm and refractive indexes between 1.39 and 1.416. Dead cells appeared at slightly smaller sizes: 2:5 µm to 5:2 µm and significantly larger refractive indexes: between 1.417 and 1.462. The overlap in size and distinction in refractive index of live and dead cells is further illustrated in FIGS. 2B and 2C. These plots are size and refractive index density distributions respectively. The size density curve in FIG. 2B, for example, is related to the probability for a particle to have a particular size. The area under the curve over any particle size range represents the number of particles that can be found in that size range. These curves are more informative and more reliable alternatives to histograms. In these graphs, the gray curves represent all particles, the orange curves represent dead cells, and the cyan curves represent live cells. In FIG. 2B the overlap of the orange and cyan curves indicates that many live and dead cells have the same size. The overlap of the size distributions shows that identifying viability by cell size alone is not reliable. Based on FIG. 2C, the orange refractive index density curve and the cyan refractive index density curve show minimal overlap suggesting that live and dead yeast cells are distinguishable by the index of refraction. In FIG. 2C, the peak of the cyan curve is near 1.4 indicating that the most common refractive index of live cells is around 1.4 while the peak of the orange curve is near 1.435 indicating that the most common refractive index of dead cells around 1.435.

FIGS. 2D-2E show results of the same yeast sample but 71 minutes after isopropanol at 15% by volume was introduced. As seen in FIG. 2D, the majority of points are orange, indicating that most of the cells have died with this exposure to alcohol. In this sample, only 2.9% of all detected particles are identified as live cells, 82.4% are identified as dead cells and 14.7% as debris. This result is represented by FIG. 2E where the gray curve and the orange curve almost match suggesting that the majority of identified particles correspond to dead cells. In FIG. 2E, only one peak is observed, corresponding to dead cells. While the cyan curve is present and dominant in FIG. 2C, it is almost entirely missing in FIG. 2E, confirming the dearth of live cells in a 15% isopropanol solution after 71 minutes.

### Comparing Viability Results Using Holographic Imaging and the TB Exclusion Assay

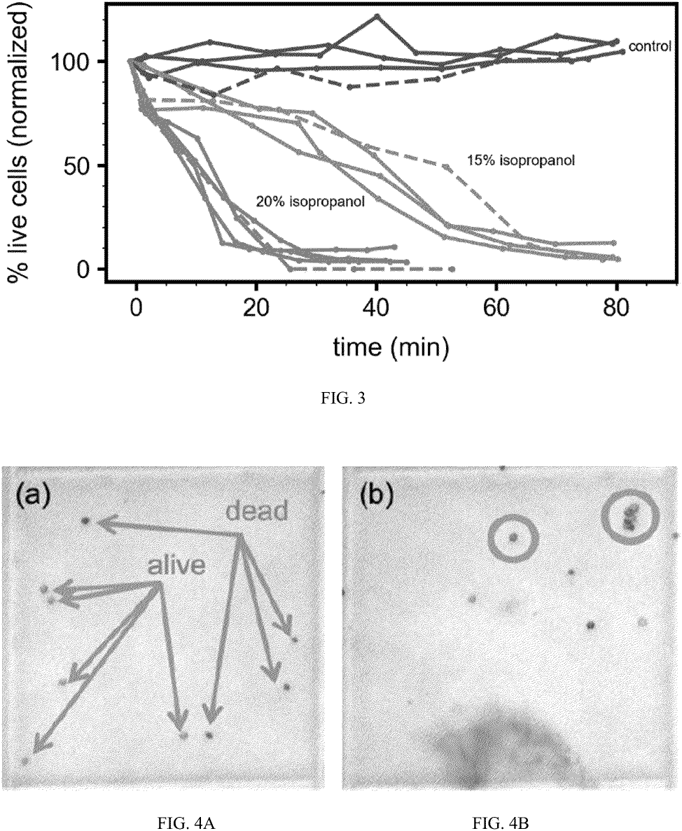

To explore how yeast respond to different concentrations of isopropanol over time and to compare the described holographic approach to the TB exclusion assay, yeast samples were exposed to 0%, 15% and 20% isopropanol by volume, and measured the resulting viability over time using both xSight and trypan blue. FIG. 3 shows the results of these studies.

In the graph in FIG. 3, the horizontal axis is the time after alcohol was added to the yeast mixture and the vertical axis is the percentage of live cells normalized by the live percentage before the alcohol is added. In FIG. 3, the solid curves represent measurements with Holographic video microscopy and the dashed curves are measurements made with the TB exclusion assay. The blue curves correspond to normalized viability of yeast samples without alcohol. While some fluctuation in those curves is observed, all curves are similar to each other and show no loss of viability over the course of 80 minutes. The yellow curves represent results for samples with added 15% alcohol by volume. A similar decrease in normalized viability over time is seen in all of the yellow curves. The orange curves represent results for samples with added 20% alcohol by volume and show a faster drop in viability as a function of time. Across all conditions, the dashed curves are similar to the solid curves suggesting strong agreement in normalized viability changes between Holographic video microscopy and the TB exclusion assay.

Note that while normalized viability results are consistent between Holographic video microscopy results and TB staining results, the absolute viabilities can vary. In fact, a consistent overestimate is observed of absolute viability using TB as compared to holographic results, which may be due to the inability of traditional staining to account for some dead cells that have degraded. Six consecutive measurements of a yeast sample with Holographic video microscopy yielded an average viability of 52:3 ± 0 :9%. The same sample measured with TB staining resulted in an average viability of 56 ± 3%. In addition to a higher viability measurement, consistent with an undercounting of dead cells, TB staining also showed a higher variability between measurements. This observation is consistent with other studies that reported such limitations in the TB staining approach.

### Traditional Staining Assay Is Often Inconclusive

Staining of Saccharomyces cerevisiae with TB showed a mixed population of live and dead cells prior to treatment with alcohol. As shown in FIG. 4A, in a single grid, a combination of live cells (unstained and labeled in blue) as well as dead cells (stained and labeled in orange) are visible. While the viability categorization is clear in FIG. 4A, it is less clear in FIG. 4B, particularly in the cases circled in gray. Cells that partially absorb the dye and those that cluster together pose a challenge for staining-based viability assays.

The presence of ambiguously stained cells, as in FIG. 4B can also contribute to the above-mentioned higher variability in staining measurements than in measurements with Holographic video microscopy.

### Definitions

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programing techniques with rule-based logic and other logic to accomplish the various connection steps, processing steps, comparison steps, and decision steps.

It is important to note that the construction and arrangement of the harmonic electromagnetic spectrometer as shown in the various exemplary embodiments is illustrative only. Additionally, any element disclosed in one embodiment may be incorporated or utilized with any other embodiment disclosed herein.

What is claimed is:

1. A method of characterizing cell viability of a plurality of cells dispersed in a fluid medium, comprising:
flowing the plurality of cells dispersed in a medium through an observation volume that is in communication with a holographic microscope;
determining optical properties of a first cell of the plurality of cells by:
generating a first holographic image based upon holographic video microscopy of the sample within the observation volume at a first time;
analyzing the first holographic image for one or more regions of interest corresponding to a first cell of the plurality of cells and applying a light scattering theory; and
determining the refractive index of the first cell; and
characterizing the first cell as viable or not viable based upon the refractive index.

2. The method of claim 1, wherein characterizing the first cell includes comparing the determined refractive index to a known viable cell refractive index.

3. The method of claim 1, wherein determining the optical properties further includes determining the radius of the first cell based upon the analysis of the first holographic image and application of the light scattering theory.

4. The method of claim 1, further comprising:
determining optical properties of a second cell of the plurality of cells by:
analyzing the first holographic image for a second regions of interest corresponding to a second cell of the plurality of cells and applying the light scattering theory;
determining the refractive index of the second cell; and
characterizing the second cell as viable or not viable based upon the refractive index.

5. A method of characterizing cell viability of a plurality of cells dispersed in a fluid medium, comprising:
flowing the plurality of cells dispersed in a medium through an observation volume that is in communication with a holographic microscope;
determining optical properties of the plurality of cells by:
generating plurality of holographic images comprising a holographic image associated with each cell of the plurality of cells based upon holographic video microscopy within the observation volume;
analyzing each of the plurality of holographic images and applying a light scattering theory;
determining the refractive index of each cell in the plurality of cells; and
determining the radius of each cell in the plurality of cells; and
mapping each cell of the plurality of cells to a graph of radius and refractive index.

6. The method of claim 5, further comprising determining cells of the plurality of cells that are viable.

7. The method of claim 5, wherein determining viable cells includes comparing the determined refractive index to a known viable cell refractive index.

8. The method of claim 5, further comprising determining cells of the plurality of cells that are not viable.

9. The method of claim 5, wherein determining not viable cells includes comparing the determined refractive index to a known viable cell refractive index.

10. The method of claim 6, wherein determining the optical properties further includes determining the radius of the first cell based upon the analysis of the first holographic image and application of the light scattering theory.

11. A method of characterizing changes over time in cell viability of a plurality of cells dispersed in a fluid medium, comprising:
flowing a first portion of the plurality of cells through an observation volume that is in communication with a holographic microscope;
determining optical properties of each cell of the first portion of the plurality of cells at a first time by:
generating a first holographic image based upon holographic video microscopy of the sample within the observation volume at a first time;
analyzing the first holographic image for one or more regions of interest corresponding to a first portion of the plurality of cells and applying a light scattering theory;
determining the refractive index of the each first portion cell of the plurality of cells; and
determining the radius of the each first portion cell of the plurality of cells;
flowing a second portion of the plurality of cells through the observation volume;
determining optical properties of each cell of the second portion of the plurality of cells at a second time by:
generating a second holographic image based upon holographic video microscopy of second portion at the second time;
analyzing the second holographic image for one or more regions of interest corresponding to a second portion of the plurality of cells and applying a light scattering theory;
determining the refractive index of each second portion cell of the plurality of cells; and
determining the radius of each second cell of each second portion cell of the plurality of cells; and
comparing one of refractive index and radius of the first portion cells at the first time to the same of refractive index and radius of the second portion cells at the second time.

12. The method of claim 11, comparing both the refractive index and radius of the first portion cells at the first time to the refractive index and radius of the second portion cells at the second time.

13. The method of claim 11, wherein characterizing the first cell includes comparing the determined refractive index to a known viable cell refractive index.

14. The method of claim 11, wherein determining the optical properties further includes determining the radius of the first cell based upon the analysis of the first holographic image and application of the light scattering theory.
